(19) United States
(12) Patent Application Publication
(10) Pub. No.: US 2024/0272931 A1
(43) Pub. Date: Aug. 15, 2024

(54) Method and apparatus for dynamic optimization of single root input/output virtualization workloads performance on a server and a client device

(71) Applicants: Arun Kumar SINGH, Portland, OR (US); Sudeep PULIGUNDLA, Hillsboro, OR (US); Satya Prasad YARLAGADDA, Portland, OR (US); Ling Yan GUO, Shanghai (CN)

(72) Inventors: Arun Kumar SINGH, Portland, OR (US); Sudeep PULIGUNDLA, Hillsboro, OR (US); Satya Prasad YARLAGADDA, Portland, OR (US); Ling Yan GUO, Shanghai (CN)

(21) Appl. No.: 18/648,654

(22) Filed: Apr. 29, 2024

(30) Foreign Application Priority Data
Nov. 30, 2023 (WO) PCT/CN2023/135391

(51) Int. Cl. G06F 9/455

(52) U.S. Cl. CPC G06F 9/45558; G06F 2009/45579

(57) ABSTRACT

A method and apparatus for dynamic optimization of single root input/output (I/O) virtualization (SR-IOV) workloads performance on a server or a client device. A function provided by an I/O endpoint device is shared by a plurality of virtual machines (VMs) or a host operating system (OS) via an I/O root device. It is determined whether a rate control is required for a workload running in a VM or the host OS based on a service level agreement (SLA) for the workload. If it is determined that a rate control is required for the workload, it is further determined whether a requirement for the workload can be satisfied based on a capability of an I/O endpoint device connected to the I/O root device. If it is determined that the requirement under the SLA for the workload can be satisfied, a rate control is performed for the workload.

### BACKGROUND

Workloads running on virtual machines (VMs) may require a high bandwidth to process data (e.g., tera bytes (TB) of data) on cloud servers. As an example, artificial intelligence workloads and network workloads may have high bandwidth requirements.

Conventional virtual functions (VFs) interfaces supported by Peripheral Component Interconnect Express (PCIe) input/output (IO) devices using Single Root IO virtualization (SR-IOV) do not support a rate control. Therefore, virtually even a single SR-IOV interface can consume all the bandwidth of the PCIe IO device (e.g., network interface card (NIC), non-volatile memory express (NVMe) solid state drives (SSD), etc.). This could lead to starvation of bandwidth to other virtualized IO workloads running on guest VMs and on host servers.

For example, giga bytes of car camera and surveillance camera data sent over a network for cloud processing, storage, and analytics can potentially consume all the bandwidth of a PCIe device endpoint through single workload and as a result other guest VMs running workloads may run into starvation and impact overall performance of other VMs. Currently there are no solutions or implementations available for servers and client devices to address this problem.

### BRIEF DESCRIPTION OF THE FIGURES

Some examples of apparatuses and/or methods will be described in the following by way of example only, and with reference to the accompanying figures, in which

FIG. 1 shows IO workloads virtualized through SR-IOV;

FIG. 2 shows an example apparatus for dynamic optimization of virtualized input/output (I/O) workloads performance on a server or a client device;

FIG. 3 shows an example apparatus supporting I/O workloads virtualized through SR-IOV using an orchestrator;

FIG. 4 shows another example apparatus supporting I/O workloads virtualized through SR-IOV using an orchestrator;

FIG. 5 is a flow diagram of an example process for dynamic optimization of SR-IOV workloads performance on a server or a client device in accordance with one example;

FIG. 6 is a block diagram of an electronic apparatus incorporating at least one electronic assembly and/or method described herein;

FIG. 7 illustrates a computing device in accordance with one implementation of the invention; and

FIG. 8 shows an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

High compute, network, and storage bandwidth processing demands keep increasing on cloud servers and client devices due to advance use cases such as deep learning workloads data, high bandwidth-consuming media and surveillance camera data transmitted over network for cloud processing and storage, or the like. Data center servers are expected to be overloaded with increased demand for high network and storage bandwidth.

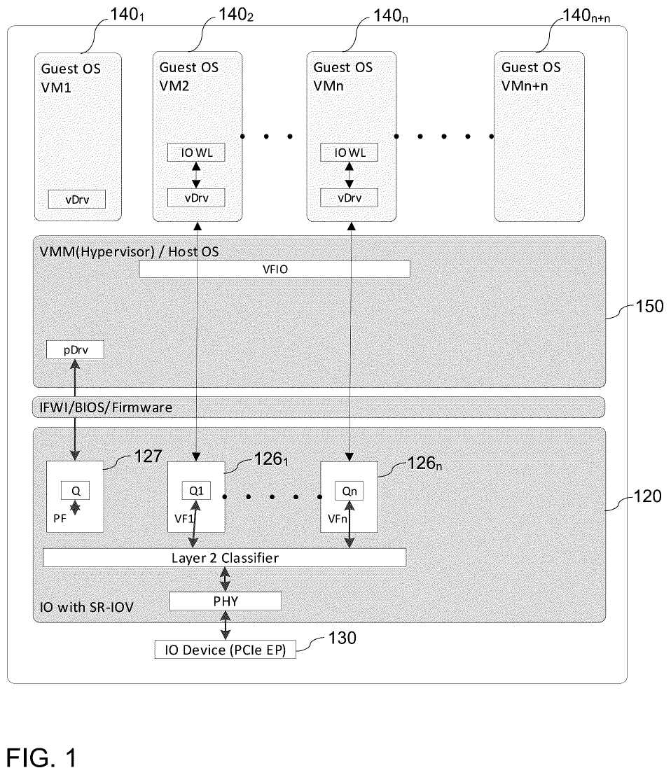

FIG. 1 shows I/O workloads virtualized through SR-IOV. SR-IOV is a technology that enables a single PCIe device (a PCIe endpoint device) to be shared among multiple VMs while maintaining the performance and security of traditional hardware. This technology is particularly relevant in data centers and cloud environments, where virtualization is a crucial element in efficiently utilizing hardware resources. SR-IOV allows a physical PCIe device (e.g., a network interface card (network adapter), a storage device, a graphics processing unit (GPU), a hardware accelerator, etc.) to appear as multiple virtual PCIe devices. Each VM may access one of the VFs of the PCIe device as if it were a dedicated physical device.

SR-IOV allows a single PCIe device (PCIe endpoint) 130 under a single PCIe root device 120 to appear to be multiple separate physical devices to a virtual machine monitor (VMM)/host operating system (OS) 150, or a guest OS 140₁-140ₙ. SR-IOV allows a PCIe device 130 to separate access to its resources among various PCIe hardware functions. These functions are a PCIe physical function (PF) 127 and one or more PCIe virtual functions (VFs) 126₁-126ₙ. A PF 127 is the primary function of the PCIe device 130. Each VF 126₁-126ₙ is associated with the device's PF 127. A VF shares one or more physical resources of the PCIe device, such as a memory and a network port, with the PF and other VFs on the device. The PF is full PCIe functions that are capable of configuring and managing the SR-IOV functionality. It is possible to configure or control PCIe devices using PFs, and the PF has full ability to move data in and out of the device. VFs are PCIe functions that support data flowing and have a restricted set of configuration resources.

A PCIe device 130 (i.e., PCIe IO SR-IOV device) supports several (e.g., 8, 32, 64, . . . , 256, etc.) SR-IOV virtual function interfaces through its physical function capabilities as defined by PCIe specifications. The maximum bandwidth supported by a PCIe I/O device 130 is fixed and depends on the capabilities of the PCIe I/O device 130, e.g., the PCIe generation (e.g., PCIe gen3, gen4, and gen5, etc.). The maximum bandwidth supported by a PCIe device 130 can be utilized by any PCIe SR-IOV virtual function interfaces, and requests are served as per transfer queue outstanding requests on PCIe root port physical function.

Examples are disclosed herein for dynamic optimization of virtualized I/O (e.g., PCIe SR-IOV) workloads performance on servers and client devices. Hereafter, the examples may be explained with reference to the PCIe SR-IOV. However, the examples are applicable to other protocols as well.

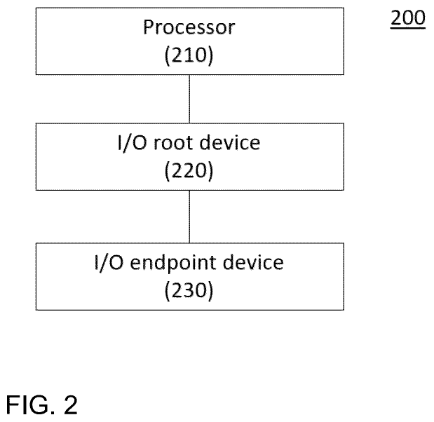

FIG. 2 shows an example apparatus for dynamic optimization of virtualized input/output (I/O) workloads performance on a server or a client device. The apparatus 200 includes a processor 210, an I/O root device 220 (e.g., a PCIe host bridge), and an I/O endpoint device 230 (e.g., a PCIe endpoint device). The processor 210 is configured to run a virtual machine monitor (VMM), a host OS, and a plurality of VMs. The VMM is a software program that enables creation, management and operating of VMs and manages the operation of a virtualized environment from the host system.

The I/O root device 220 is connected to the processor 210. The I/O root device 220 connects the processor 210 and a memory subsystem (not shown) to one or more I/O endpoint devices 230. The I/O root device 220 generates transaction requests on behalf of the processor 210, which is interconnected through a local bus. The I/O root device 220 includes one or more ports, and one or more I/O endpoint devices 230 may be connected to the ports on the I/O root device 220.

The I/O endpoint device 230 is connected to the I/O root device 220. SR-IOV is implemented in the system 200 such that a function provided by the I/O endpoint device 230 may be shared by the plurality of VMs via the I/O root device 220. The I/O endpoint device 230 may be a network interface card (NIC), a storage device (e.g., an SSD), a graphics processing unit (GPU), a hardware accelerator, or the like.

A plurality of VMs may be set up on the host and workloads may be running simultaneously in the VMs. Workloads (computing workloads) refer to the tasks, applications, processes, etc. that a computing machine can handle. The VMM or the host OS may be configured to determine whether a rate control/bandwidth control/load balancing (hereafter simply “rate control”) is required for a workload running in a virtual machine or the host OS based on a service level agreement (SLA) for the workload. A rate control is implemented to allocate/map virtual functions and/or PCIe endpoint devices to VMs or host for providing a proper bandwidth to the workloads running in the VMs or host, which in turn avoids the bandwidth starvation problem and makes sure workloads successfully execute and complete based on their SLA requirements. If it is determined that a rate control is required for the workload based on the SLA, the VMM or the host OS may determine whether a requirement for the workload under the SLA can be satisfied based on a capability of an I/O endpoint device 230 connected to the I/O root device 220. The requirement for the workload may include at least one of a bandwidth requirement, a delay/latency requirement, or a priority of the workload. If it is determined that the requirement under the SLA for the workload can be satisfied, the VMM or the host OS may perform a rate control for the workload.

In examples, an orchestrator (scheduler) may be provided in the VMM or the host operating system and in the host firmware for the I/O endpoint device 230 to perform the rate control/load balancing for the workload. The orchestrator is a software module that is responsible for controlling and scheduling workloads in the VMs and the host OS.

In some examples, the orchestrator may be configured to map the workload to one of a plurality of virtual functions supported by the I/O endpoint device 230 based on the requirement for the workload. For example, each of the plurality of virtual functions may be associated with a priority (or any quality of service (QoS) measure) and the orchestrator may map the workload to one of the plurality of virtual functions based on the priority (or the QoS measure) of the virtual functions and the requirement of the workload. The orchestrator may switch mapping of the workload to one of the virtual functions based on the requirement for the workload.

In some examples, a plurality of I/O endpoint devices are connected to the I/O root device 220 and the orchestrator may be configured to map the workload to one of a plurality of I/O endpoint devices connected to the I/O root device 220 based on the requirement for the workload and capabilities of the plurality of I/O endpoint devices. For example, two or more I/O endpoint devices in different generations may be connected to the I/O root device 220 and the orchestrator may map the workload to one of the I/O endpoint devices in different generations based on the requirement for the workload and capabilities of the plurality of I/O endpoint devices. The orchestrator is configured to switch mapping of the workload to one of the plurality of I/O endpoint devices based on the requirement for the workload and available bandwidths of the plurality of I/O endpoint devices.

In examples, the capabilities of the I/O endpoint devices 230 are extended through an orchestrator (scheduler) that performs rate control and load balancing. This can provide a predictable data-rate/bandwidth control mechanism. With this scheme, (critical) workloads running into guest VMs and on host may get sufficient network, storage, or other workloads bandwidth to perform the (time critical) processing and avoid a bandwidth starvation situation. Each workload running into virtual machines and on host can get fair share of available data transfer bandwidth. Servers, client platforms, or customers can benefit from this solution and scale server infrastructure and supporting PCIe IO endpoints device hardware by efficiently optimizing resource sharing to different workloads running into VMs.

Example schemes for dynamic optimization of virtualized IO (e.g., PCIe SR-IOV) workloads performance will be explained in detail hereafter.

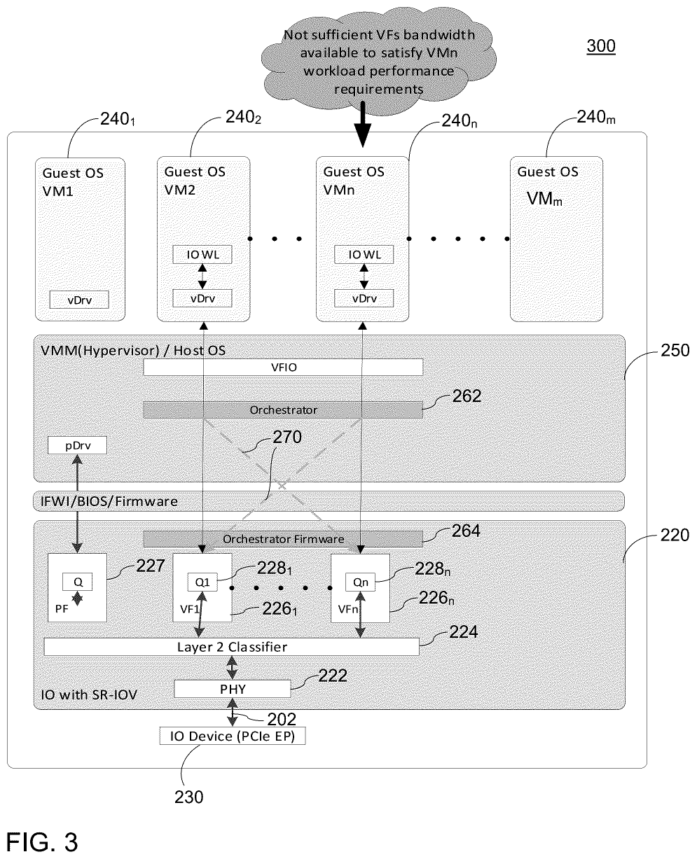

FIG. 3 shows an example apparatus 300 supporting I/O workloads virtualized through SR-IOV using an orchestrator (scheduler). The apparatus 300 includes a processor 210, an I/O root device 220, and an I/O endpoint device 230 (e.g., a PCIe endpoint device). A plurality of VMs 240₁-240ₘ may be set up and workloads may be performed in the VMs simultaneously.

The I/O endpoint device 230 is a peripheral device such as a network interface card (e.g., Ethernet device), a storage device (e.g., an NVMe SSD), a GPU, a hardware accelerator, etc. The I/O endpoint device 230 supports several (e.g., 8, 32, 64, . . . , 256, etc.) SR-IOV virtual functions (VFs) 226₁-226ₙ through its physical function (PF) 227, e.g., as defined by PCIe specifications. The maximum bandwidth supported by the I/O endpoint device 230 is fixed and depends on the capabilities of the I/O endpoint device 230, e.g., the PCIe generation (e.g., PCIe gen3, gen4, and gen5, etc.). The maximum bandwidth supported by the I/O endpoint device 230 can be utilized by any SR-IOV virtual functions 226₁-226ₙ.

The I/O root device 220 include a plurality of ports and one or more I/O endpoint devices 230 may be connected to the I/O root device 220. The I/O root device 220 includes physical layer circuitry (PHY) 222, a layer 2 classifier 224, and a plurality of queues 228₁-228ₙ. The PHY 222 is responsible for sending and receiving data to and from the I/O endpoint device 230 across the link 202 (e.g., a PCIe link). The PHY 222 interacts with the layer 2 and the link 202. For the packets received from the I/O endpoint device 230, the layer 2 classifier (sorter) 224 sorts and determines which VM each packet is destined for and then places the packet in a receive queue 228₁-228ₙ assigned to that VM. The VMM 250 (hypervisor) then routes the received packets to the respective VM 240₁-240ₘ. The VMM 250 (hypervisor) manages network I/O activities for all VMs 240₁-240ₘ. As packets are transmitted from the VMs 240₁-240ₘ toward the I/O endpoint device 230, the VMM 250 places the transmit data packets in their respective queues 228₁-228ₙ. To prevent blocking and ensure each queue is fairly serviced, the queued packets may be transmitted on the link 202 in a round-robin fashion, thereby guaranteeing some degree of quality of service (QoS) to the VMs 240₁-240ₘ.

In examples, an orchestrator (scheduler) 262 and 264 for bandwidth rate control/load balancing is included in the VMM/host OS 250 and the host device firmware, respectively, for the I/O endpoint device 230 (e.g., a PCIe I/O endpoint) to regulate a sufficient bandwidth allocation to each workload running into the VMs 240₁-240ₘ and on the host OS. In examples, the orchestrator (scheduler) implementation belongs to VMM (hypervisor), a host OS, and a device firmware. In examples, one or more of the VMs may not have sufficient VFs bandwidth to satisfy the VMs workload performance requirements. In such case, the orchestrator (scheduler) 262 and 264 performs a rate control/load balancing for the workloads when it is determined by the VMM or the host OS 250 to implement a rate control/load balancing for the workload. For example, the orchestrator (scheduler) 262 and 264 may map one of the virtual functions 226₁-226ₙ to each virtual machine 240₁-240ₘ based on the requirement of the workload running in the virtual machine 240₁-240ₘ. For example, each virtual function 226₁-226ₙ may be associated with a priority (or any quality of service (QoS) measure) and each workload may be mapped to one of the virtual functions 226₁-226ₙ based on the requirements of the workload. For example, a time-critical workload may be mapped to a high-priority/QoS virtual function and a delay-tolerant workload may be mapped to a low-priority/QoS virtual function. In examples, instead of statically allocating virtual functions 226₁-226ₙ to the virtual machines 240₁-240ₘ, the virtual functions 226₁-226ₙ may be dynamically allocated to the virtual machines 240₁-240ₘ based on the requirements of the workloads. In examples, the orchestrator 262, 264 may dynamically switch the mapping of the virtual functions 226₁-226ₙ to the virtual machines 240₁-240ₘ, as illustrated by arrows 270.

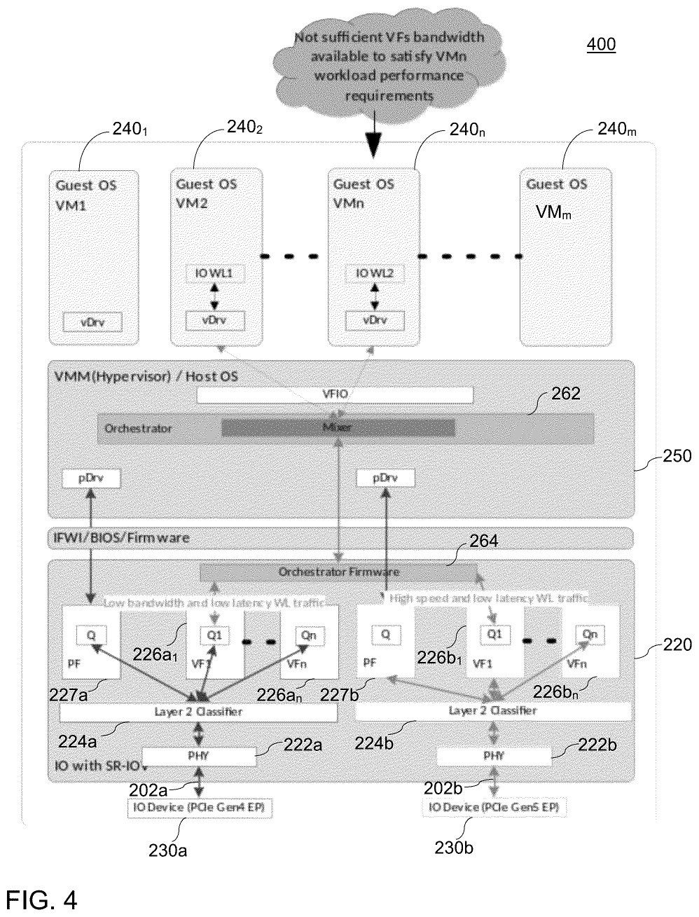

FIG. 4 shows another example apparatus 400 supporting I/O workloads virtualized through SR-IOV using an orchestrator (scheduler). The apparatus 400 includes a processor, an I/O root device 220, and an I/O endpoint device 230 (e.g., a PCIe endpoint device). A plurality of VMs 240₁-240ₘ may be set up and workloads may be performed in the VMs simultaneously. The apparatus 400 is similar to the apparatus 300 in FIG. 3, but instead of a single I/O endpoint device 230 is connected to the I/O root device 220 as shown in FIG. 3, two I/O endpoint devices 230a and 230b are connected to the I/O root device 220 in FIG. 4. It should be noted that the number of I/O endpoint devices 230 connected to the I/O root device 220 is not limited to what is shown in FIGS. 3 and 4, and any number of I/O endpoint devices 230 may be connected to the I/O root device 220.

The I/O endpoint devices 230a and 230b are a peripheral device such as a network interface card (e.g., Ethernet device), a storage device (e.g., an NVMe SSD), a GPU, a hardware accelerator, etc. The I/O endpoint devices 230a and 230b support several (e.g., 8, 32, 64, . . . , 256, etc.) SR-IOV virtual functions (VFs) 226a₁-226aₙ and 226b₁-226bₙ, respectively through its respective physical function (PF) 227a and 227b, e.g., as defined by PCIe specifications. The maximum bandwidth supported by the I/O endpoint devices 230a, 230b is fixed and depends on the capabilities of the I/O endpoint devices 230a, 230b, e.g., the PCIe generation (e.g., PCIe gen3, gen4, and gen5, etc.). The maximum bandwidth supported by the I/O endpoint device 230a, 230b can be utilized by any SR-IOV virtual functions 226a₁-226aₙ and 226b₁-226bₙ. In this example, two I/O endpoint devices 230a and 230b with different capabilities (e.g., in different generations) are connected to the I/O root device 220.

The I/O root device 220 include a plurality of ports and one or more I/O endpoint devices 230 may be connected to the I/O root device 220. The I/O root device 220 includes physical layer circuitry (PHY) 222a, 222b, a layer 2 classifier 224a, 224b, and a plurality of queues. The PHY 222a/222b is responsible for sending and receiving data to and from the I/O endpoint device 230s, 230b across the links 202a, 202b (e.g., a PCIe link), respectively. The PHY 222a/222b interacts with the layer 2 and the links 202a, 202b. For the packets received from the I/O endpoint device 230a/230b, the layer 2 classifier (sorter) 224a/224b sorts and determines which VM each packet is destined for and then places the packet in a receive queue assigned to that VM. The VMM 250 (hypervisor) then routes the received packets to the respective VM 240₁-240ₘ. The VMM 250 (hypervisor) manages network I/O activities for all VMs 240₁-240ₘ. As packets are transmitted from the VMs 240₁-240ₘ toward the I/O endpoint device 230a/230b, the VMM 250 places the transmit data packets in their respective queues. To prevent blocking and ensure each queue is fairly serviced, the queued packets may be transmitted on the link 202a/202b in a round-robin fashion, thereby guaranteeing some degree of quality of service (QoS) to the VMs 240₁-240ₘ.

In examples, an orchestrator (scheduler) 262 and 264 for bandwidth rate control/load balancing is included in the VMM/host OS 250 and the device (endpoint device) firmware, respectively, for the I/O endpoint device 230a/230b (e.g., a PCIe I/O endpoint) to regulate a sufficient bandwidth allocation to each workload running into the VMs 2401-240m and on the host OS. In examples, the orchestrator (scheduler) implementation belongs to VMM (hypervisor), a host OS, and a host firmware. In examples, one or more of the VMs may not have sufficient VFs bandwidth to satisfy the VMs workload performance requirements. In such case, the orchestrator (scheduler) 262 and 264 performs a rate control/load balancing for the workloads when it is determined by the VMM or the host OS 250 to implement a rate control/load balancing for the workload. The orchestrator 262 (a mixer in the orchestrator 262) may map a workload to one of the I/O endpoint devices 230a/230b based on the requirements of the workload and capabilities of the I/O endpoint devices 230a/230b. Here, the terms “scheduler” and “mixer” can be used interchangeably wherein the mixer gets different VM's workloads characteristics and manages sharing of endpoint device bandwidth among several VM's workloads. For example, the orchestrator 262 and 264 may resolve the bandwidth starvation problem by dynamically moving critical workloads to a high-performing I/O endpoint device when needed and other (non-critical) workloads to a low-performing I/O endpoint device. The orchestrator 262/264 may switch mapping of the workload to one of the plurality of I/O endpoint devices 230a/230b based on the requirement for the workload and available bandwidths of the plurality of I/O endpoint devices 230a/230b. In an example shown in FIG. 4, the I/O endpoint device 230a is a low-speed generation 4 device, and the I/O endpoint device 230b is a high-speed generation 5 device. The orchestrator 262 may map a workload traffic requiring a high speed/bandwidth to the I/O endpoint device 230b and map a workload traffic not requiring a high speed/bandwidth to the I/O endpoint device 230a.

In addition, the orchestrator (scheduler) 262 and 264 may also map one of the virtual functions 226a₁-226aₙ/226b₁-226bₙ to each virtual machine 240₁-240ₘ based on the requirement of the workload running in the virtual machine 240₁-240ₘ. For example, each virtual function 226a₁-226aₙ/226b₁-226bₙ may be associated with a priority (or any QoS measure) and each workload may be mapped to one of the virtual functions 226a₁-226aₙ/226b₁-226bₙ based on the requirements of the workload. For example, a time-critical workload may be mapped to a high-priority/QoS virtual function and a delay-tolerant workload may be mapped to a low-priority/QoS virtual function. In examples, instead of statically allocating virtual functions 226a₁-226aₙ/226b₁-226bₙ to the virtual machines 240₁-240ₘ, the virtual functions 226a₁-226aₙ/226b₁-226bₙ may be dynamically allocated to the virtual machines 240₁-240ₘ based on the requirements of the workloads. In examples, the orchestrator 262, 264 may dynamically switch the mapping of the virtual functions 226a₁-226aₙ/226b₁-226bₙ to the virtual machines 240₁-240ₘ.

The orchestrator 262 (the mixer) evaluates the requirements of the workloads under the SLA (e.g., a bandwidth requirement, a latencies requirement, etc.) and available I/O endpoint device capabilities such as a link speed and current bandwidth traffic available and consumed and instructs the orchestrator firmware 264 to dynamically switch workloads traffic to low or high bandwidth and latencies I/O endpoint devices (e.g., PCIe gen4 or gen5 endpoint devices). This may require retraining PCIe endpoints for supported link speed and capabilities and the host OS or hypervisor PCIe endpoint drivers need to initiate instructions to reconfigure the I/O endpoint devices.

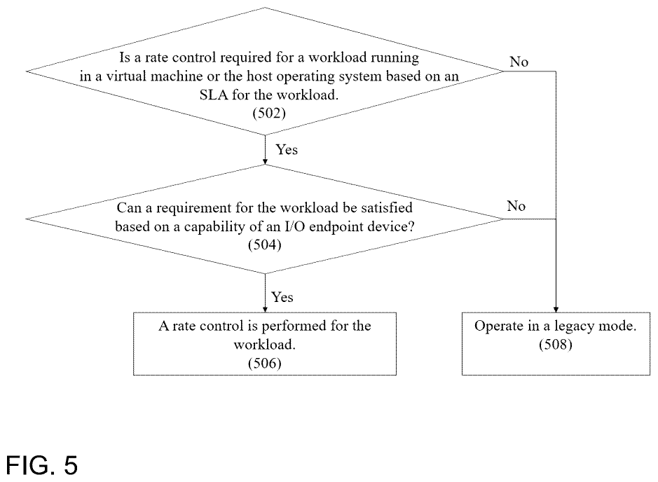

FIG. 5 is a flow diagram of an example process for dynamic optimization of SR-IOV workloads performance on a server or a client device in accordance with one example. A function provided by an I/O endpoint device is shared by a plurality of VMs or a host operating system via an I/O root device. The VMM/hypervisor or the host OS is initially configured for implementing a rate control and load balancing for SR-IOV virtual functions among existing SR-IOV VFs for specific I/O endpoint devices (e.g., a network card, a storage device, a GPU, a hardware accelerator, etc.). It is determined whether a rate control is required for a workload running in a virtual machine or the host operating system based on an SLA for the workload (502). The requirements under the SLA for the workload and the supported bandwidth/capabilities by the I/O endpoint devices are input into the system and the VMM or the host OS may make the determination based on this information.

If it is determined that a rate control is required for the workload based on the SLA, it is further determined whether a requirement for the workload under the SLA can be satisfied based on a capability of an I/O endpoint device connected to the I/O root device (504). The requirement for the workload may include at least one of a bandwidth requirement, a delay/latency requirement, a priority of the workload, or the like.

If it is determined that the requirement under the SLA for the workload can be satisfied, a rate control may be performed for the workload (506). In examples, an orchestrator (scheduler) modules may be provided in a virtual machine manager/the host operating system and the host firmware to perform the rate control for the workload. The orchestrator firmware of the I/O endpoint device (e.g., a PCIe endpoint) may implement a rate control/load balancing among all SR-IOV VFs supported by the I/O endpoint device as instructed by the orchestrator in the VMM/host OS.

For example, the orchestrator in the VMM/host OS and the host firmware may map the workload to one of a plurality of virtual functions supported by the endpoint I/O device based on the requirements of the workload. The orchestrator may switch mapping of the workload to one of the virtual functions based on the requirements for the workload.

In some examples, a plurality of I/O endpoint devices with different capabilities (e.g., I/O endpoint devices in different generations) may be connected to the I/O root port, and the orchestrator may map the workload to one of a plurality of I/O endpoint devices connected to the I/O root device based on the requirement for the workload and capabilities of the plurality of I/O endpoint devices. The orchestrator may switch mapping of the workload to one of the plurality of I/O endpoint devices based on the requirement for the workload and available bandwidths of the plurality of I/O endpoint devices.

If it is determined that a rate control/load balancing is not required for the workload based on the SLA or the requirement for the workload under the SLA cannot be satisfied based on a capability of an I/O endpoint device connected to the I/O root device, the system may operate in a legacy mode and execute workloads using a default method (e.g., based on a first-come first-served basis) (508). With this scheme, the VM or the host OS may run workloads using SR-IOV VFs with a predicted SLA and avoid any deadlock or starvation situations.

The example schemes disclosed herein provide capabilities to over-subscribe virtual functions support on SR-IOV XPUs without denial of service with appropriate quality of service (QoS) to manage committed SLAs. The example schemes disclosed herein can resolve the bandwidth limitation to support a number of virtual functions supported by a SR-IOV device physical function by implementing a rate control/load balancing mechanism into the VMM and the SR-IOV device firmware. The rate control or bandwidth sharing mechanism for I/O virtualization solution in accordance with the examples disclosed herein can provide scalable architecture implementation for SR-IOV I/O devices (e.g., Ethernet, GPU, etc.) in data centric servers, Internet-of-Things (IoT) edge compute and client devices environment. It can also enhance SR-IOV devices capabilities to accommodate more guest VMs with a fewer number of I/O devices.

Data servers and edge compute devices can be benefited by the solutions disclosed herein. Devices supporting high number of cores can greatly utilize the feature implementation disclosed herein considering the latency they can tolerate to use a software method in combination with hardware acceleration support. The rate control/load balancing and bandwidth sharing mechanism of SR-IOV devices can be used for the server and client workloads which expect hard latency requirements or SLAs such as Time Stamp Network (TSN) Ethernet cards. The solutions disclosed herein can help avoid deadlock or starvation situation for critical workloads running into host or guest VMs.

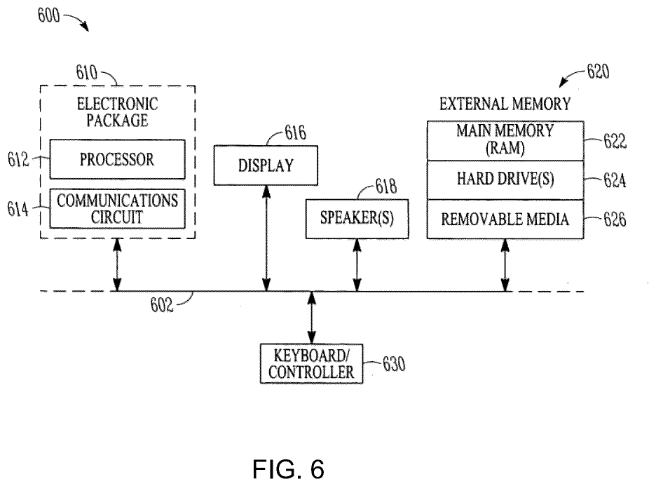

FIG. 6 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-speciﬁc integrated circuit (ASlC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), ﬂash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

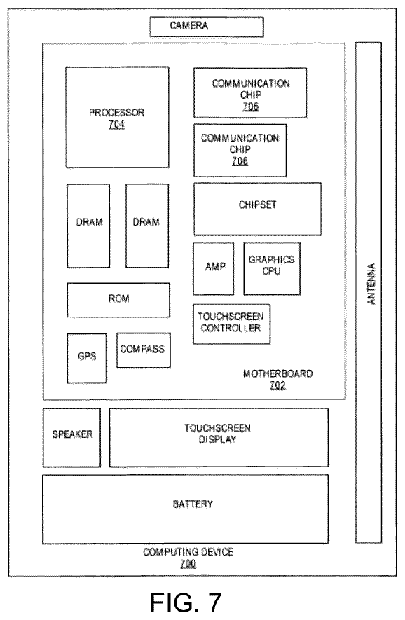

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), ﬂash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a ﬁrst communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based P0P package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based P0P package that that includes a mold layer directly contacting a substrate, in accordance with implementations of the invention.

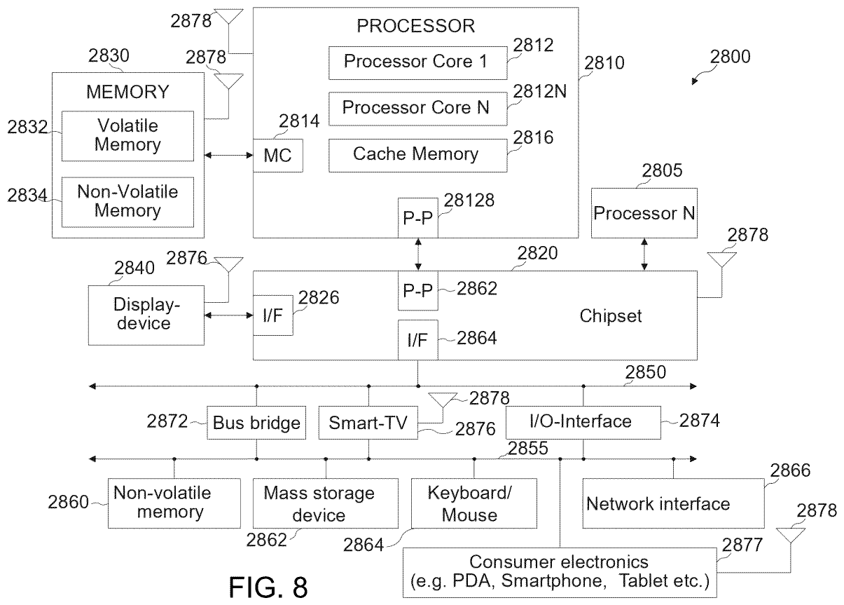

FIG. 8 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for dynamic optimization of SR-IOV workloads performance on a server or a client device. A function provided by an I/O endpoint device is shared by a plurality of VMs or a host operating system via an I/O root device. The method includes determining whether a rate control is required for a workload running in a virtual machine or the host operating system based on a SLA for the workload, if it is determined that a rate control is required for the workload based on the SLA, determining whether a requirement for the workload under the SLA can be satisfied based on a capability of an I/O endpoint device connected to the I/O root device, and if it is determined that the requirement under the SLA for the workload can be satisfied, performing a rate control for the workload.

Another example, (e.g., example 2) relates to a previously described example (e.g., example 1), wherein an orchestrator in a virtual machine manager or the host operating system performs the rate control for the workload.

Another example, (e.g., example 3) relates to a previously described example (e.g., example 2), wherein the orchestrator maps the workload to one of a plurality of virtual functions supported by the endpoint I/O device based on the requirement for the workload.

Another example, (e.g., example 4) relates to a previously described example (e.g., example 3), wherein the orchestrator switches mapping of the workload to one of the virtual functions based on the requirement for the workload.

Another example, (e.g., example 5) relates to a previously described example (e.g., any one of examples 2-4), wherein the orchestrator maps the workload to one of a plurality of I/O endpoint devices connected to the I/O root device based on the requirement for the workload and capabilities of the plurality of I/O endpoint devices.

Another example, (e.g., example 6) relates to a previously described example (e.g., example 5), wherein the orchestrator switches mapping of the workload to one of the plurality of I/O endpoint devices based on the requirement for the workload and available bandwidths of the plurality of I/O endpoint devices.

Another example, (e.g., example 7) relates to a previously described example (e.g., any one of examples 1-6), wherein the requirement for the workload includes at least one of a bandwidth requirement, a delay requirement, or a priority of the workload.

Another example, (e.g., example 8) relates to a previously described example (e.g., any one of examples 1-7), wherein the I/O endpoint device is one of a network interface card, a storage device, a GPU, or a hardware accelerator.

Another example, (e.g., example 9) relates to an apparatus for dynamic optimization of SR-IOV workloads performance. The apparatus includes a processor configured to run a VMM, a host operating system, and a plurality of VMs, an I/O root device connected to the processor, and an I/O endpoint device connected to the I/O root device. A function provided by the I/O endpoint device is shared by the plurality of VMs and the host operating system via the I/O root device. The VMM or the host operating system is configured to determine whether a rate control is required for a workload running in a virtual machine or the host operating system based on a SLA for the workload, if it is determined that a rate control is required for the workload based on the SLA, determine whether a requirement for the workload under the SLA can be satisfied based on a capability of an I/O endpoint device connected to the I/O root device, and if it is determined that the requirement under the SLA for the workload can be satisfied, perform a rate control for the workload.

Another example, (e.g., example 10) relates to a previously described example (e.g., example 9), wherein an orchestrator in the VMM or the host operating system is configured to perform the rate control for the workload.

Another example, (e.g., example 11) relates to a previously described example (e.g., example 10), wherein the orchestrator is configured to map the workload to one of a plurality of virtual functions supported by the I/O endpoint device based on the requirement for the workload.

Another example, (e.g., example 12) relates to a previously described example (e.g., example 11), wherein the orchestrator is configured to switch mapping of the workload to one of the virtual functions based on the requirement for the workload.

Another example, (e.g., example 13) relates to a previously described example (e.g., any one of examples 10-12), wherein the orchestrator is configured to map the workload to one of a plurality of I/O endpoint devices connected to the I/O root device based on the requirement for the workload and capabilities of the plurality of I/O endpoint devices.

Another example, (e.g., example 14) relates to a previously described example (e.g., example 13), wherein the orchestrator is configured to switch mapping of the workload to one of the plurality of I/O endpoint devices based on the requirement for the workload and available bandwidths of the plurality of I/O endpoint devices.

Another example, (e.g., example 15) relates to a previously described example (e.g., any one of examples 9-14), wherein the requirement for the workload includes at least one of a bandwidth requirement, a delay requirement, or a priority of the workload.

Another example, (e.g., example 16) relates to a previously described example (e.g., any one of examples 9-15), wherein the I/O endpoint device is one of a network interface card, a storage device, a GPU, or a hardware accelerator.

Another example, (e.g., example 17) relates to a non-transitory machine-readable medium including code, when executed, to cause a machine to perform the method as in any one of examples 1-8.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for dynamic optimization of single root input/output (I/O) virtualization (SR-IOV) workloads performance on a server or a client device, wherein a function provided by an I/O endpoint device is shared by a plurality of virtual machines (VMs) or a host operating system via an I/O root device, comprising:
determining whether a rate control is required for a workload running in a virtual machine or the host operating system based on a service level agreement (SLA) for the workload;
if it is determined that a rate control is required for the workload based on the SLA, determining whether a requirement for the workload under the SLA can be satisfied based on a capability of an I/O endpoint device connected to the I/O root device; and
if it is determined that the requirement under the SLA for the workload can be satisfied, performing a rate control for the workload.

2. The method of claim 1, wherein an orchestrator in a virtual machine manager or the host operating system performs the rate control for the workload.

3. The method of claim 2, wherein the orchestrator maps the workload to one of a plurality of virtual functions supported by the endpoint I/O device based on the requirement for the workload.

4. The method of claim 3, wherein the orchestrator switches mapping of the workload to one of the virtual functions based on the requirement for the workload.

5. The method of claim 2, wherein the orchestrator maps the workload to one of a plurality of I/O endpoint devices connected to the I/O root device based on the requirement for the workload and capabilities of the plurality of I/O endpoint devices.

6. The method of claim 5, wherein the orchestrator switches mapping of the workload to one of the plurality of I/O endpoint devices based on the requirement for the workload and available bandwidths of the plurality of I/O endpoint devices.

7. The method of claim 1, wherein the requirement for the workload includes at least one of a bandwidth requirement, a delay requirement, or a priority of the workload.

8. The method of claim 1, wherein the I/O endpoint device is one of a network interface card, a storage device, a graphics processing unit (GPU), or a hardware accelerator.

9. An apparatus for dynamic optimization of single root input/output (I/O) virtualization (SR-IOV) workloads performance, comprising:
a processor configured to run a virtual machine monitor (VMM), a host operating system, and a plurality of virtual machines (VMs);
an I/O root device connected to the processor; and
an I/O endpoint device connected to the I/O root device, wherein a function provided by the I/O endpoint device is shared by the plurality of VMs and the host operating system via the I/O root device,
wherein the VMM or the host operating system is configured to:
determine whether a rate control is required for a workload running in a virtual machine or the host operating system based on a service level agreement (SLA) for the workload,
if it is determined that a rate control is required for the workload based on the SLA, determine whether a requirement for the workload under the SLA can be satisfied based on a capability of an I/O endpoint device connected to the I/O root device, and
if it is determined that the requirement under the SLA for the workload can be satisfied, perform a rate control for the workload.

10. The apparatus of claim 9, wherein an orchestrator in the VMM or the host operating system is configured to perform the rate control for the workload.

11. The apparatus of claim 10, wherein the orchestrator is configured to map the workload to one of a plurality of virtual functions supported by the I/O endpoint device based on the requirement for the workload.

12. The apparatus of claim 11, wherein the orchestrator is configured to switch mapping of the workload to one of the virtual functions based on the requirement for the workload.

13. The apparatus of claim 10, wherein the orchestrator is configured to map the workload to one of a plurality of I/O endpoint devices connected to the I/O root device based on the requirement for the workload and capabilities of the plurality of I/O endpoint devices.

14. The apparatus of claim 13, wherein the orchestrator is configured to switch mapping of the workload to one of the plurality of I/O endpoint devices based on the requirement for the workload and available bandwidths of the plurality of I/O endpoint devices.

15. The apparatus of claim 9, wherein the requirement for the workload includes at least one of a bandwidth requirement, a delay requirement, or a priority of the workload.

16. The apparatus of claim 9, wherein the I/O endpoint device is one of a network interface card, a storage device, a graphics processing unit (GPU), or a hardware accelerator.

17. A non-transitory machine-readable medium including code, when executed, to cause a machine to perform the method of claim 1.
